(19) United States
(12) Patent Application Publication
(10) Pub. No.: US 2023/0266953 A1
(43) Pub. Date: Aug. 24, 2023

(54) CONTROL METHOD, INFORMATION PROCESSING APPARATUS, AND STORAGE MEDIUM

(71) Applicant: CANON KABUSHIKI KAISHA, Tokyo (JP)

(72) Inventors: Yoshinori Yamaguchi, Kanagawa (JP); Jun Ehara, Kanagawa (JP)

(21) Appl. No.: 18/166,410

(22) Filed: Feb. 8, 2023

(30) Foreign Application Priority Data
Feb. 21, 2022 (JP) 2022-024924

(51) Int. Cl. H04N 1/00; H04N 1/32

(52) U.S. Cl. CPC H04N 1/00395; H04N 1/00244; H04N 1/32598; H04N 1/00315

(57) ABSTRACT

A method for controlling an information processing apparatus includes acquiring identification information for a communication apparatus from the communication apparatus, and displaying information indicating one or more connection interfaces included in the communication apparatus, the one or more connection interfaces being identified based on the identification information, wherein, in a case where the acquired identification information is acquired from the communication apparatus including a plurality of connection interfaces, information indicating the plurality of connection interfaces is displayed.

### BACKGROUND

### Field

The present disclosure relates to a control method, an information processing apparatus, and a storage medium.

### Description of the Related Art

A technique for setting up a communication apparatus (e.g., a printer) via a connection interface included in the communication apparatus is known.

Japanese Patent Application Laid-Open No. 2021-100159 discusses a technique for setting up a communication apparatus by using a service set identifier (SSID) transmitted by the communication apparatus having a wireless local area network (LAN) interface. Further improvements in user-friendliness are demanded for the technique for setting up a communication apparatus.

### SUMMARY

According to an aspect of the present disclosure, a method for controlling an information processing apparatus comprises acquiring identification information for a communication apparatus from the communication apparatus, and displaying information indicating one or more connection interfaces included in the communication apparatus, the one or more connection interfaces being identified based on the acquired identification information, wherein, in a case where the acquired identification information is acquired from the communication apparatus including a plurality of connection interfaces, information indicating the plurality of connection interfaces is displayed.

Further features will become apparent from the following description of exemplary embodiments with reference to the attached drawings.

### BRIEF DESCRIPTION OF THE DRAWINGS

FIG. 1 illustrates a system configuration.

FIG. 2 illustrates hardware configurations of an information processing apparatus and a communication apparatus.

FIG. 3 is a flowchart illustrating processing of a setup program.

FIG. 4 illustrates a selection screen of a setup target printing apparatus.

FIG. 5 illustrates a setup Service Set Identifier (SSID) for the printing apparatus.

FIG. 6 illustrates examples of tables.

FIG. 7 illustrates selection screens for a connection interface (I/F) to be used for setup processing.

FIG. 8 illustrates selection screens for setup target installation software.

FIG. 9 is another flowchart illustrating processing of the setup program.

FIG. 10 illustrates other examples of tables.

### DESCRIPTION OF THE EMBODIMENTS

Exemplary embodiments will be described below with reference to the accompanying drawings. It is to be understood that the scope of the present disclosure includes modifications and improvements of the following exemplary embodiments suitably performed based on ordinary knowledge of those skilled in the art without departing from the spirit and scope of the present disclosure.

An information processing apparatus and a communication apparatus included in a communication system according to a first exemplary embodiment will be described below. While the present exemplary embodiment describes a personal computer (PC) as an example of an information processing apparatus, this is not seen to be limiting. Various types of information processing apparatuses such as a smartphone, portable terminal, tablet terminal, personal digital assistant (PDA), and digital camera are also applicable. The present exemplary embodiment describes a printing apparatus (printer) as an example of a communication apparatus, but this is not seen to be limiting. Various types of apparatuses capable of wirelessly communicating with an information processing apparatus are also applicable. Examples of applicable printers include a multifunction printer (MFP) that provides copy services, FAX services, and printing services. Examples of applicable printers also include an ink jet printer, full-color laser beam printer, and monochromatic printer. Examples of applicable communication apparatuses include printers as well as a copying machine, facsimile apparatus, portable terminal, smartphone, notebook personal computer (PC), tablet terminal, PDA, digital camera, music player, television, and smart speaker. Examples of applicable communication apparatuses also include a multifunction peripheral having a plurality of functions such as a copy function, a FAX function, and a printing function. A smart speaker is used to issue processing instructions to devices existing in the same network following the user's voice, and notify the user of the information acquired via the network in response to the user's voice. In addition, a single function printer (SFP) having a single function is also applicable.

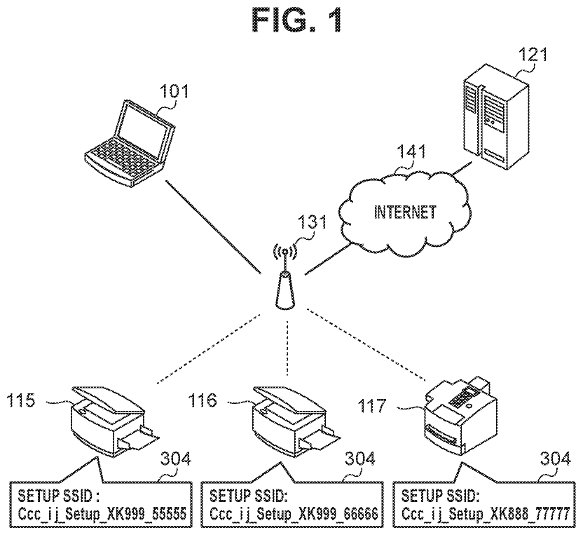

FIG. 1 illustrates an overall configuration of the system according to the present exemplary embodiment. An information processing apparatus 101 is connected to a wireless local area network (LAN) router (access point) 131. The information processing apparatus 101 communicates with a server 121 via the wireless LAN router 131 and the Internet 141. Printing apparatuses 115, 116, and 117 are not connected with the wireless LAN router 131, and unconnected states are indicated by dotted lines. While the printing apparatuses 115, 116, and 117 are not connected with the wireless LAN router 131, the wireless LAN interface (not illustrated) of each printing apparatus transmits a setup service set identifier (SSID) 304 as a beacon. As illustrated in FIG. 1, the setup SSID 304 differs for each printing apparatus, and includes information for identifying each printing apparatus. The beacon transmission is started at the timing of an instruction via the input interface 102 (described below) in the printing apparatuses 115, 116, and 117, and the timing when power of the printing apparatuses 115, 116 and 117 is turned ON.

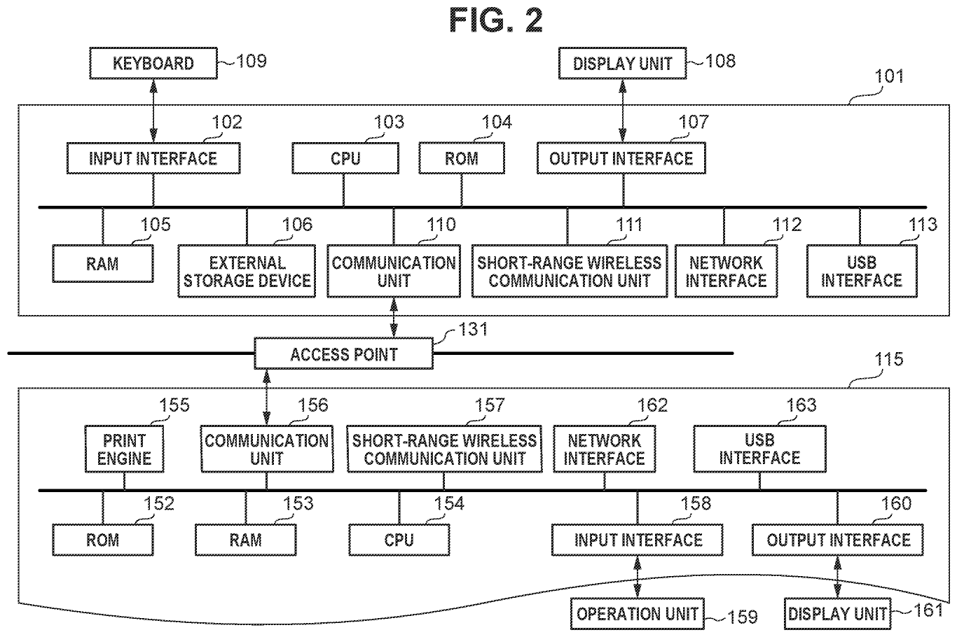

A configuration of the information processing apparatus according to the present exemplary embodiment and a configuration of the communication apparatus that communicates with the information processing apparatus according to the present exemplary embodiment will be described below with reference to FIG. 2.

The present exemplary embodiment will be described below with respect to the following example configurations. The present exemplary embodiment is applicable to an apparatus that communicates with the communication apparatus. The functions of the apparatuses are not limited to the configurations in FIG. 2. For description purposes, the communication apparatus will be described below based on the printing apparatus 115, however, the printing apparatuses 116 and 117 have a configuration similar to that of the printing apparatus 115.

The information processing apparatus 101 according to the present exemplary embodiment includes an input interface 102, a central processing unit (CPU) 103, a read only memory (ROM) 104, a random access memory (RAM) 105, an external storage device 106, an output interface 107, a display unit 108, a keyboard 109, a communication unit 110, a short-range wireless communication unit 111, a network interface 112, and a universal serial bus (USB) interface 113. The CPU 103, the ROM 104, the RAM 105, and other units form the computer of the information processing apparatus 101.

The input interface 102 receives input data and operating instructions from the user when an operation unit such as the keyboard 109 is operated. The operation unit can include a physical keyboard and physical buttons, or a software keyboard and software buttons displayed on the display unit 108. More specifically, the input interface 102 can receive inputs (operations) from the user via the display unit 108.

The CPU 103 as a system control unit controls the information processing apparatus 101.

The ROM 104 stores fixed data including control programs to be executed by the CPU 103, data table, and a built-in operating system (OS) program. According to the present exemplary embodiment, each control program stored in the ROM 104 performs software execution control including scheduling, task switching, and interrupt processing under the control of the built-in OS stored in the ROM 104.

The RAM 105 includes a static random access memory (SRAM) requiring a backup power source. Since the data in the RAM 105 is retained by a primary battery for data backup (not illustrated), program control variables and other important data can be stored without concern for being erased. The RAM 105 is also provided with a storage area for storing setting information and management data for the information processing apparatus 101. The RAM 105 is also used as the main memory and work memory for the CPU 103.

The external storage device 106 stores an application program for performing setup processing of the printing apparatus 115 (hereinafter referred to as a setup program), and a printing information generation program for generating printing information that can be interpreted by the printing apparatus 115. For example, the setup program performs the setup processing.

Examples of the setup processing include processing for instructing the printing apparatus 115 to connect with the Internet 141 via the connection interface (I/F) selected by the user, and processing for installing installable software. Examples of the setup processing also includes processing for installing the printer driver of the printing apparatus 115 and processing for generating a print queue, by using the information acquired from the printing apparatus 115 by the information processing apparatus 101. More specifically, the setup processing includes processing for connecting the information processing apparatus 101 and the printing apparatus 115 to instruct the printing apparatus 115 to perform print processing based on print data. The connection I/F will be described below.

The setup program can include functions other than execution of the setup processing. For example, the setup program can include a function of instructing the printing apparatus 115 to perform printing, a function of instructing the printing apparatus 115 to scan a set document, and a function of checking the status of the printing apparatus 115. The setup program is installed, for example, by the external server 121 via the Internet communication via the communication unit 110, and then stored in the external storage device 106. The external storage device 106 stores various programs including an information transmission and reception control program for transmitting and receiving data to/from the connected printing apparatus 115 via the communication unit 110. The external storage device 106 also stores various types of information used by these programs.

The output interface 107 controls the display unit 108 to display data and notify the user of the status of the information processing apparatus 101. The display unit 108 includes light emitting diodes (LEDs) or a liquid crystal display (LCD), and displays data and notifies the user of the status of the information processing apparatus 101.

The communication unit 110 connects with an apparatus such as the printing apparatus 115 and an access point (AP) 131 to perform data communication. For example, the communication unit 110 can be connected with an access point (not illustrated) in the printing apparatus 115. When the communication unit 110 connects with the access point in the printing apparatus 115, the information processing apparatus 101 and the printing apparatus 115 can communicate with each other. The communication unit 110 can wirelessly communicate directly with the printing apparatus 115, or communicate with the printing apparatus 115 via an external apparatus existing external to the information processing apparatus 101 and external to the printing apparatus 115. Examples of the external apparatus include an external access point (such as the access point 131) existing external to the information processing apparatus 101 and outside the printing apparatus 115, and an apparatus other than an access point that can relay communication. According to the present exemplary embodiment, the wireless communication method used by the communication unit 110 is the Wireless Fidelity (Wi-Fi)® communication standard conforming to the IEEE 802.11 series. Examples of the access point 131 include the wireless LAN router 131. According to the present exemplary embodiment, a connection method in which the information processing apparatus 101 and the printing apparatus 115 directly connect with each other without using an external access point is referred to as a direct connection method. A connection method in which the information processing apparatus 101 and the printing apparatus 115 connect with each other via an external access point is referred to as an infrastructure connection method.

The short-range wireless communication unit 111 wirelessly connects with an apparatus such as the printing apparatus 115 within a short range to perform data communication with the apparatus. The short-range wireless communication unit 111 performs communication based on a communication method different from that of the communication unit 110. For example, the short-range wireless communication unit 111 can connect with a short-range wireless communication unit 157 in the printing apparatus 115. Examples of short-range communication methods include Near Field Communication (NFC), Bluetooth® Classic, Bluetooth® Low Energy, and Wi-Fi Aware™.

The network interface 112 is a connection I/F for controlling communication processing via a wireless method and communication processing via a wired LAN cable. More specifically, the network interface 112 is used to connect with the printing apparatus 115 or an external apparatus external to the information processing apparatus 101 and external to the printing apparatus 115 via a wireless LAN or a wired LAN to perform data communication with the apparatus. More specifically, the network interface 112 is provided with both a wireless LAN and a wired LAN as connection I/Fs. For example, the network interface 112 can be connected with an access point (not illustrated) in the printing apparatus 115. When the network interface 112 connects with the access point in the printing apparatus 115, the information processing apparatus 101 and the printing apparatus 115 can communicate with each other. The network interface 112 can perform only wireless or wired communication. More specifically, the information processing apparatus 101 can include, for example, only the network interface 112 for wireless or wired communication and the USB interface 113 (described below) as interfaces for communicating with other apparatuses.

The USB interface 113 is a connection I/F for controlling a USB connection via a USB cable. More specifically, the USB interface 113 connects with apparatuses such as the printing apparatus 115 and the external access point 131 via USB to perform data communication.

As described above, the printing apparatus 115 will be described as the communication apparatus according to the present exemplary embodiment, and that the configuration of the printing apparatuses 116 and 117 are similar to that of the printing apparatus 115. The printing apparatus 115 includes a ROM 152, a RAM 153, a CPU 154, a print engine 155, a communication unit 156, a short-range wireless communication unit 157, an input interface 158, an operation unit 159, an output interface 160, a display unit 161, a network interface 162, and a USB interface 163. The ROM 152, the RAM 153, the CPU 154, and other units form the computer of the printing apparatus 115.

The communication unit 156 controls communication processing using different interfaces such that the printing apparatus 115 operates in two different communication modes: an infrastructure mode and a peer-to-peer (P2P) mode.

The infrastructure mode is a communication mode in which the printing apparatus 115 communicates with the information processing apparatus 101 or other apparatuses via an external apparatus (e.g., the access point 131) that forms a network. A connection with an external access point established by the printing apparatus 115 operating in the infrastructure mode is referred to as an infrastructure connection. According to the present exemplary embodiment, the printing apparatus 115 operates as a slave station, and the external access point operates as the master station in the infrastructure connection. According to the present exemplary embodiment, the master station refers to an apparatus that determines the communication channel to be used by the network to which the master station belongs, and the slave station refers to an apparatus that uses the communication channel determined by the master station instead of determining the communication channel to be used by the network to which the slave station belongs.

The P2P mode is a communication mode in which the printing apparatus 115 directly communicates with the information processing apparatus 101 or other apparatuses without using an external apparatus forming the network. According to the present exemplary embodiment, the P2P mode includes an AP mode in which the printing apparatus 115 operates as an access point. Connection information (SSID and password) of the access point enabled in the printing apparatus 115 in the AP mode can be optionally set by the user. The P2P mode can include, for example, a Wi-Fi Direct® (WFD) mode in which the printing apparatus 115 performs communication via WFD. Which one of a plurality of WFD-based apparatuses operates as the master station is determined, for example, based on a sequence called a Group Owner Negotiation. The master station can be determined without execution of the Group Owner Negotiation. The WFD-based apparatus that plays the role of the master station is referred to as a Group Owner. When the printing apparatus 115 operating in the P2P mode establishes a direct connection with other apparatuses, this connection is referred to as a direct connection. In the direct connection according to the present exemplary embodiment, the printing apparatus 115 operates as the master station, and other apparatuses operate as slave stations.

The short-range wireless communication unit 157 wirelessly connects with an apparatus such as the information processing apparatus 101 over a short distance range. For example, the short-range wireless communication unit 157 can connect with the short-range wireless communication unit 111 in the information processing apparatus 101. Examples of short-range communication methods include NFC, Bluetooth® Classic, Bluetooth® Low Energy, and Wi-Fi Aware™.

The RAM 153 includes a Static RAM (SRAM) requiring a backup power source. Since the data in the RAM 153 is retained by a primary battery for data backup (not illustrated), program control variables and other important data can be stored without concern for being erased. The RAM 153 is provided with a storage area for storing setting information and management data for the printing apparatus 115. The RAM 153 is also used as the main memory and work memory for the CPU 154. The RAM 153 serves as a receive buffer for temporarily storing printing information received from the information processing apparatus 101 and stores various information.

The ROM 152 stores fixed data including control programs to be executed by the CPU 154, data table, and a built-in OS program. According to the present exemplary embodiment, each control program stored in the ROM 152 performs software execution control including scheduling, task switching, and interrupt processing under the control of the built-in OS stored in the ROM 152.

The CPU 154 serves as a system control unit for controlling the printing apparatus 115.

The print engine 155 applies a recording material such as ink to a recording medium such as paper based on information stored in the RAM 153 and a print job received from the information processing apparatus 101, thus forming an image on the recording medium. The print engine 155 then outputs a printing result. Generally, since a print job transmitted from the information processing apparatus 101 has a large amount of data, a communication method enabling high-speed communication is required for communication of a print job. Therefore, the printing apparatus 115 receives a print job via the communication unit 156 capable of performing communication at higher speeds than the short-range wireless communication unit 157.

Memories such as an external Hard Disk Drive (HDD) and a Secure Digital (SD) card can be attached to the printing apparatus 115 as optional devices, and information to be stored in the printing apparatus 115 can be stored in these memories.

The input interface 158 receives input data and operating instructions from the user when the operation unit 159 such as physical buttons is operated. The operation unit 159 can include a software keyboard and software buttons displayed on the display unit 161.

More specifically, the input interface 158 can receive an input from the user via the display unit 161.

The output interface 160 controls the display unit 161 to display data and notify the user of the status of the printing apparatus 115. The display unit 161 includes LEDs or an LCD to display data and notify the user of the status of the printing apparatus 115.

The network interface 162 controls communication processing via a wireless method and communication processing via a wired LAN cable. More specifically, the network interface 162 has an access point for connecting with an apparatus such as the information processing apparatus 101 as an internal access point of the printing apparatus 115. The access point is connectable with the network interface 112 of the information processing apparatus 101. When the network interface 162 enables the internal access point, the printing apparatus 115 operates as an access point. The network interface 162 can be directly wirelessly connected with the information processing apparatus 101 or wirelessly connected with the information processing apparatus 101 via the access point 131.

According to the present exemplary embodiment, the wireless communication method used by the network interface 162 is a communication standard conforming to the IEEE 802.11 series. In the following descriptions, Wireless Fidelity (Wi-Fi®) (Wi-Fi® communication) is a communication method conforming to the IEEE 802.11 series. The network interface 162 can include a hardware component that functions as an access point, or can function as an access point via software for making the network interface 162 function as an access point.

The USB interface 163 controls a USB connection via a USB cable. More specifically, the USB interface 163 connects with such apparatus as the printing apparatus 115 and an external access point via USB to perform data communication.

According to the present exemplary embodiment, the information processing apparatus 101 performs setup processing. For example, the information processing apparatus 101 performs processing for connecting with the printing apparatus 115 via a predetermined connection interface (hereinafter referred to as a connection I/F or setup interface) to instruct the printing apparatus 115 to perform print processing based on print data. The connection I/F refers to a connection method for enabling the information processing apparatus 101 and the printing apparatus 115 to communicate with each other. For example, in the setup processing, the information processing apparatus 101 communicates with the printing apparatus 115 via the connection I/F of the printing apparatus 115, such as the USB interface 163 and the network (NW) interface 162, and installs software related to the printing apparatus 115. Communication with the printing apparatus 115 via the NW interface 162 includes both communication with the printing apparatus 115 via a wireless LAN interface and communication with the printing apparatus 115 via a wired LAN interface. The information processing apparatus 101 perform processing for installing installation software related to the printing apparatus 115. Examples of the installation software include software for editing image data and instructing the printing apparatus 115 to perform printing. In the setup processing, the information processing apparatus 101 displays on the display unit 108 a notification that enables the user to select the connection I/F to be used and the software to be installed when performing communication with the printing apparatus 115. Then, upon receipt of the selected connection I/F from the user, the information processing apparatus 101 communicates with the printing apparatus 115 via the selected connection I/F and then installs the selected software.

Communication apparatuses of different models can include (support) different numbers of connection I/Fs (one or more connection I/Fs). For example, a model A can include a USB and a wireless LAN as connection I/Fs, while a model B can include a USB and a wired LAN as connection I/Fs.

Conventionally, when the user performs the setup processing of the communication apparatus by using a setup program, the setup program displays all of the connection I/F options prepared in the setup program as connection I/Fs that can be used between the information processing apparatus 101 and the communication apparatus. More specifically, when the user performs the setup processing of the communication apparatus, the setup program does not conventionally provide different connection I/F options for different models of communication apparatuses. As a result, when the user selects a connection I/F not included in the communication apparatus, the setup processing of the communication apparatus can possibly fail.

Even when a customer demands to restrict the user's use of a specific connection I/F included in the communication apparatus, providing the specific connection I/F can possibly enable the user to select the specific connection I/F. Examples of customer's demands to restrict the user's use of a specific connection I/F included in the communication apparatus include a demand regarding the printing apparatus 115 provided with a USB and a wireless LAN interface as connection I/Fs, i.e., a demand not to enable the user to use the wireless LAN interface for security reasons. This means that the customer's demand may not be satisfied if the setup program displays all of the connection I/Fs prepared by the setup program and the user selects a restricted connection I/F.

When the setup program installs one or more pieces of software selected by the user, the setup program displays, for example, all pieces of software that can be provided using the setup program as options for the user to select which pieces of software are to be installed. More specifically, the setup program does not conventionally display different pieces of software for different models of communication apparatuses. As a result, when the user selects software not supported by the communication apparatus (software that cannot instruct the communication apparatus to perform an operation), the setup processing of the communication apparatus can possibly fail.

Even when a customer demands to restrict the user's use of specific software that can instruct a communication apparatus (to be purchased by the customer) to perform an operation, providing specific software can possibly enables the user to select the specific software.

Examples of customer's demands to restrict the user's use of specific software supported by the communication apparatus include a demand regarding a model of a printing apparatus supporting both software A and B, i.e., a demand not to enable the user to install software A for security reasons. This means that the customer's demand may not be satisfied if the setup program displays all of the software that can be provided by using the setup program and then the user selects a restricted software option.

For this reason, according to the present exemplary embodiment, the setup program acquires identification information for the communication apparatus.

Based on the acquired identification information, the setup program notifies the user of identified connection I/F options and identified software options, and does not notify the user of unidentified connection I/F options and unidentified software options.

This enables reducing the possibility of the setup processing failure as a result of the user selecting an interface not included in the communication apparatus. If a customer demands to restrict the user's use of a specific interface included in the communication apparatus, the possibility of providing the specific interface option that enables the user to select the specific interface can be reduced.

This enables reducing the possibility that the installation processing fails as a result of the user selecting software that cannot instruct the communication apparatus to perform an operation. If a customer demands to restrict the user's use of specific software that cannot instruct the communication apparatus to perform an operation, the possibility of providing specific software option that enables the user to select the specific software can be reduced.

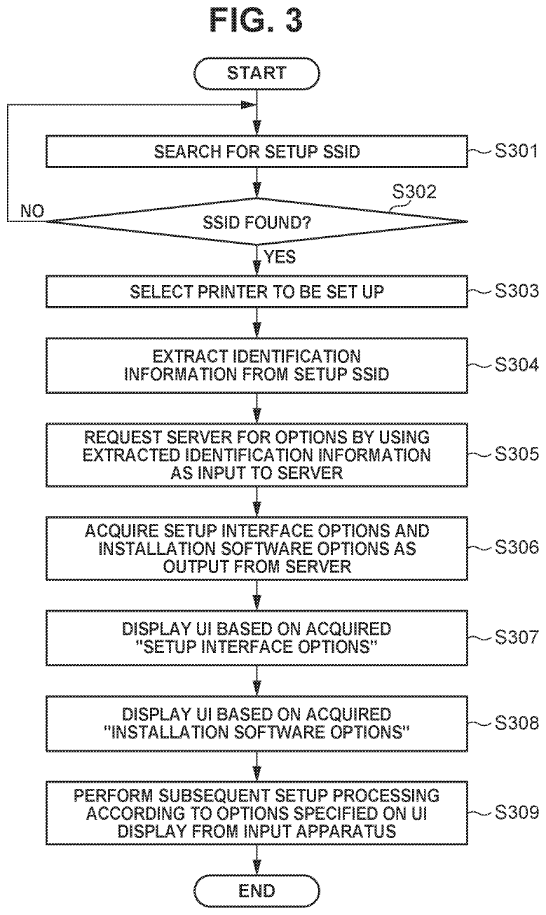

FIG. 3 is a flowchart illustrating processing performed by the information processing apparatus 101 in the printing apparatus setup processing according to the present exemplary embodiment. The flowchart illustrated in FIG. 3 is implemented, for example, when the CPU 103 loads the setup program stored in the ROM 104 or the external storage device 106 into the RAM 105, and then executes the setup program. The flowchart illustrated in FIG. 3 is started upon execution of a predetermined operation (hereinafter referred to as a setup operation) for performing the setup processing in the screen displayed by the setup program.

In step S301, the CPU 103 searches for the above-described setup SSID 304 transmitted from the printing apparatus 115, 116, or 117 via the wireless LAN interface included in the information processing apparatus 101. More specifically, the CPU 103 acquires information about the printing apparatus 115, 116, or 117 via the wireless LAN interface by using the application programming interface (API) of the operating system (OS) included in the information processing apparatus 101.

In step S302, the CPU 103 determines whether the setup SSID 304 is found (detected). If the CPU 103 determines that the setup SSID 304 is found (YES in step S302), the processing proceeds to step S303. If the CPU 103 determines that the setup SSID 304 is not found (NO in step S302), the processing returns to step S301. In this case, it is not a prerequisite that the CPU 103 performs the search again. For example, if the setup SSID 304 is not detected after a predetermined time has elapsed, the CPU 103 displays all of the connection I/F options prepared by the setup program. If the user selects the wireless LAN interface, the CPU 103 can display the method for instructing the printing apparatuses 115, 116, and 117 to transmit the setup SSID 304 via the input interface 158, on the display unit 108 of the information processing apparatus 101, and then perform step 301 again. In a case where a connection I/F other than the wireless LAN interface is selected from among all of the connection I/F options prepared in the setup program displayed when the setup SSID 304 is not detected after a predetermined time has elapsed, the processing in steps S303 to S308 can be skipped. Connection I/Fs other than the wireless LAN interface include the wired interface or the USB interface. Example cases where the setup SSID 304 is not detected include a case where a setup SSID transmitted by the printing apparatus 115 not supported by the setup program is transmitted.

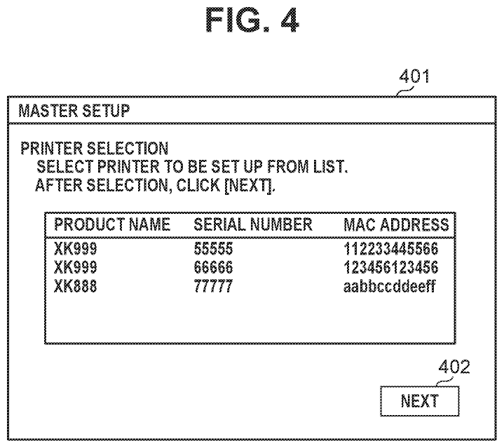

In step S303, the CPU 103 displays the printing apparatus based on the detected setup SSID 304 on the display unit 108 of the information processing apparatus 101. For description purposes, a case where the printing apparatus 115, 116, or 117 is detected is described. An example of a displayed UI screen is illustrated in FIG. 4. On the screen 401 in FIG. 4, the user selects one of the printing apparatuses 115, 116, and 117 to be set up by using input interfaces such as the mouse of the information processing apparatus 101, and then selects a “Next” button 402. Thus, the CPU 103 recognizes the printing apparatus selected by the user as the printing apparatus 115 to be set up. In this case, the selected printing apparatus is assumed to be the printing apparatus 115.

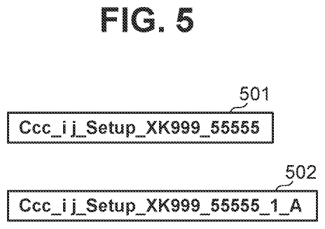

In step S304, the CPU 103 extracts the identification information for the printing apparatus from the setup SSID 304 of the selected printing apparatus. The setup SSID 304 of the printing apparatus 115 is illustrated as an item 501 in FIG. 5. The CPU 103 extracts, from among the character strings of the setup SSID 304 delimited by underscores, the last (rightmost) character string as the serial number (individual identification information) and the second rightmost character string as the model name. The serial number is determined to identify an individual of the printing apparatus 115, and differs for each of printing apparatuses of the same model. In this case, a model name “XK999” and a serial number “55555” are extracted. The setup SSID 304 does not necessarily need to include the entire serial number, and can include only a part of the serial number. The serial number does not necessarily need to be included in the setup SSID 304, and the extraction of the serial number is not a prerequisite. If the model name is not included in the setup SSID 304, the CPU 103 can display all of the connection I/F options prepared by the setup program, without performing steps S305 and S306 (described below). More specifically, in a case where the printing apparatus 115 is selected in step S303, the CPU 103 determines whether the model name is included in the setup SSID 304. If the CPU 103 determines that the model name is included in the setup SSID 304, the CPU 103 performs processing in step S304 and subsequent steps. If the CPU 103 determines that the model name is not included in the setup SSID 304, the processing skips steps S305 and S306 and proceeds to step S307. In step S307, the CPU 103 displays all of the connection I/F options prepared by the setup program. The CPU 103 displays all of the software options that can be provided by the setup program in step S308 (described below). If the model name is not included in the setup SSID 304, the product name (model name) is not displayed in the display screen in FIG. 4.

In a case where the model name is not included in the setup SSID 304, the display form of the CPU 103 is not limited thereto. For example, if the serial number is included and the model name is not included in the setup SSID 304, the CPU 103 performs the processing in step S305 and subsequent steps. In this case, the CPU 103 acquires information about the connection I/F options and the installation software options based on the serial number, and displays the acquired connection I/F options and installation software options in steps S307 and S308.

In step S305, the CPU 103 requests the server 121 to return information about the supported connection I/Fs and information about the supported installation software based on either the model name or the serial number of the printing apparatus 115. More specifically, the CPU 103 transmits a request for transmitting information about connection I/Fs that can be used by the printing apparatus 115 in connection processing with the information processing apparatus, and information about installation software that operates on the printing apparatus 115. For example, the CPU 103 requests the server 121 to return information about the connection I/Fs and the installation software supported by the printing apparatus 115, by using the model name “XK999” and the serial number “55555” as an input to the server 121.

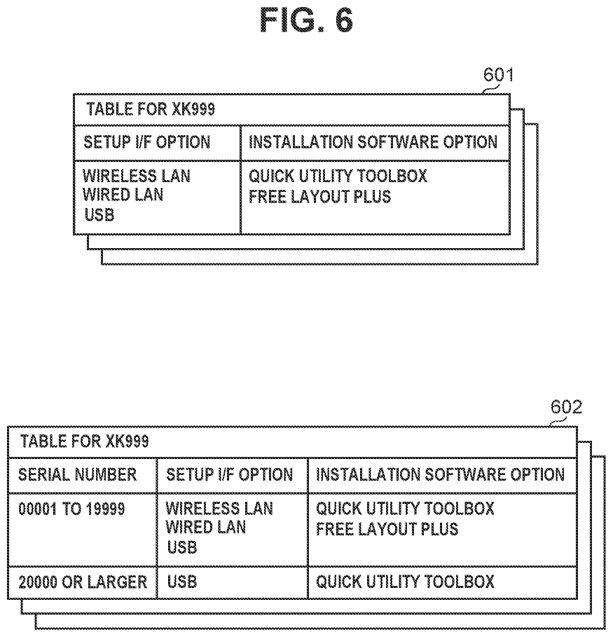

In step S306, the CPU 103 receives information about the connection I/Fs and information about the installation software returned from the server 121. The conversion from input to output is performed by using tables stored in the server 121. For example, in a case where the model name “XK999” is input to the server 121, a table 601 illustrated in FIG. 6 is used. In this case, based on the table values, “Wireless LAN/Wired LAN/USB” is output as the information about the connection I/Fs, and “Quick Utility Toolbox/Free Layout Plus” is output as the information about the installation software. For example, in a case where the model name “XK999” and the serial number “55555” are input to the server 121, a table 602 illustrated in FIG. 6 is used. In this case, based on the table values, “USB” is output as the information about the connection I/Fs and “Quick Utility Toolbox” is output as the information about the installation software.

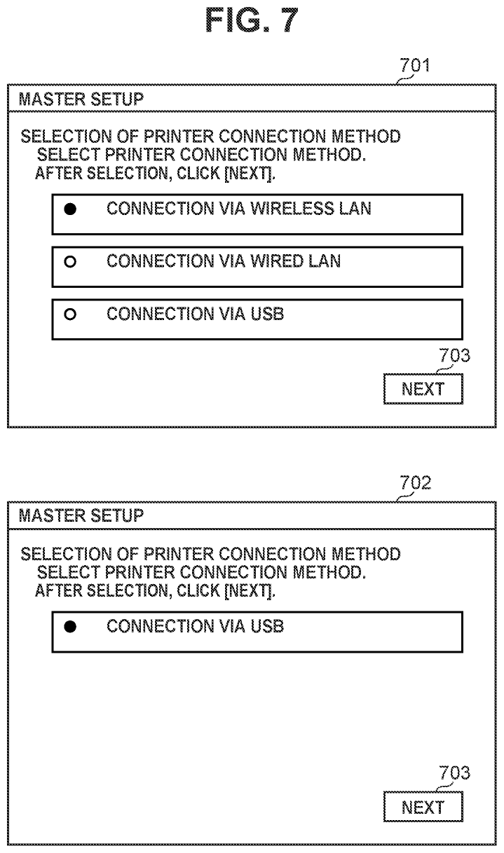

In step S307, the CPU 103 displays the information about the connection I/Fs acquired in step S306 as options on the display unit 108 of the information processing apparatus 101. Examples of display screens are illustrated in FIG. 7. Assume a case where the CPU 103 requests the server 121 to return information about the connection I/Fs and information about the installation software by using the model name “XK999” as an input to the server 121 in step S305. When the values obtained by referring to the table 601 in FIG. 6 are returned from the server 121, a display screen 701 is displayed. Assume a case where the CPU 103 requests the server 121 to return information about the connection I/Fs and information about the installation software by using the model name “XK999” and the serial number “55555” as an input to the server 121 in step S305. When the values obtained by referring to the table 602 in FIG. 6 are returned from the server 121, a display screen 702 is displayed. This means that the connection I/Fs supported by the printing apparatus 115 can differ based on the serial number, even with the same model name of the printing apparatus 115. Examples of cases where the connection I/Fs supported by the printing apparatus 115 differ based on the serial number include a case where the connection I/Fs included in the printing apparatus 115 differ based on the serial number and a case where the connection I/Fs included in the printing apparatus 115 do not differ based on the serial number but the options to be displayed based on a customer's demand are restricted. Therefore, referencing the serial number of the printing apparatus 115 in addition to the model name thereof enables displaying in more detail the connection I/Fs supported by the printing apparatus 115 to be set up.

Referring to the screens 701 and 702 in FIG. 7, the user selects one of the connection I/Fs to be used in the setup processing of the printing apparatus 115 by using the input interface 102 such as the mouse of the information processing apparatus 101, and then selects a “Next” button 703. This enables the CPU 103 to recognize the connection I/F to be used in the setup processing of the printing apparatus 115. In a case where only one connection I/F option is acquired in step S306, step S307 can be skipped.

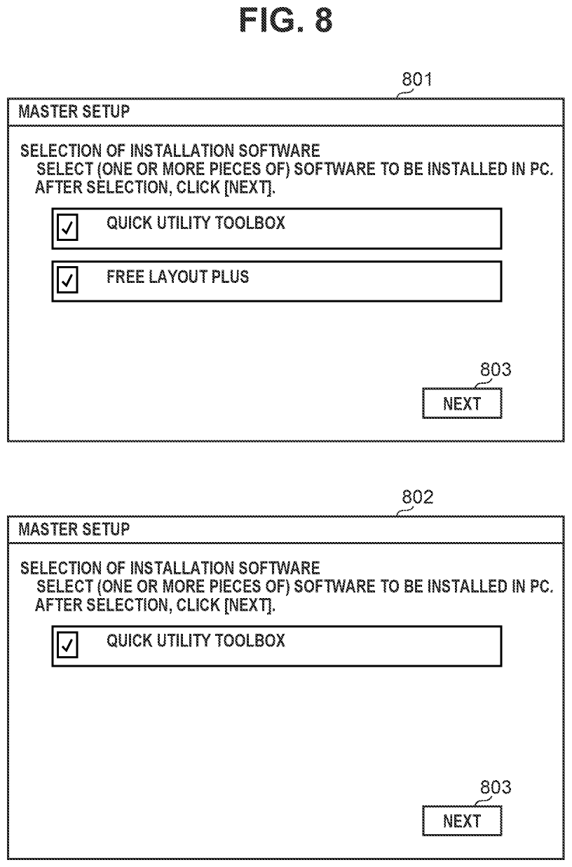

In step S308, the CPU 103 displays the information about the installation software acquired in step S306 as options on the display unit 108 of the information processing apparatus 101. Examples of display screens are illustrated in FIG. 8. Assume a case where the CPU 103 requests the server 121 to return information about the connection I/Fs and information about the installation software by using the model name “XK999” as an input to the server 121 in step S305. When the values obtained by referring to the table 601 in FIG. 6 are returned from the server 121, a display screen 801 is displayed. Assume a case where the CPU 103 requests the server 121 to return information about the connection I/Fs and information about the installation software by using the model name “XK999” and the serial number “55555” as an input to the server 121 in step S305. When the values obtained by referring to the table 602 in FIG. 6 are returned from the server 121, a display screen 802 is displayed. This means that the installation software supported by the printing apparatus 115 can differ based on the serial number, even with the same model name of the printing apparatus 115. Therefore, referencing the serial number of the printing apparatus 115 in addition to the model name thereof enables displaying in more detail the installation software supported by the printing apparatus 115 to be set up.

Referring to the screens 801 and 802 in FIG. 8, the user selects the software to be installed by using the input interfaces 102 such as the mouse of the information processing apparatus 101, and then selects a “Next” button 803. This enables the CPU 103 to recognize the software to be installed in the setup processing of the printing apparatus 115. The processing in step S308 can also be skipped. In that case, the CPU 103 operates on the premise that all of the installation software options acquired in step S306 are selected. The order of the processing in steps S307 and S308 can be reversed.

In step S309, the CPU 103 performs the subsequent setup processing of the printing apparatus 115, 116 or 117 based on the information about the connection I/F selected in step S307 and the information about the installation software selected in step S308. Then, the CPU 103 ends the processing. The subsequent setup processing includes processing for enabling communication between the information processing apparatus 101 and the printing apparatus 115 via the connection I/F specified by the user in step S307, and processing for installing the software specified by the user. Examples of processing for enabling communication between the information processing apparatus 101 and the printing apparatus 115 via the specified connection I/F include processing for connecting the printing apparatus 115 with the access point 131 forming a network when the user selects the wireless LAN interface. More specifically, the information processing apparatus 101 transmits the connection information (including the SSID and password) for the access point 131 to the printing apparatus 115 via the Wi-Fi® connection between the information processing apparatus 101 and an internal access point enabled by the printing apparatus 115. Then, the printing apparatus 115 connects with the access point 131 by using the received connection information for the access point 131 to connect with the network formed by the access point 131. While this processing uses the Wi-Fi® communication method, this is not seen to be limiting. For example, the processing can be performed using a communication method other than Wi-Fi®, such as Bluetooth® Low Energy. In a case where the wired LAN is selected, the setup program displays a tutorial screen (notification screen) (not illustrated) leading to a message indicating the setup method using the wired LAN and a web manual indicating the setup method using the wired LAN. While the tutorial screen is displayed, the CPU 103 searches for a printing apparatus via the wired LAN. In a case where USB is selected, the CPU 103 displays a message that prompts to connect a USB cable.

The notification screen can display, for example, the identification information (including the serial number, media access control address (MAC) address) for the target printing apparatus. The notification screen can include, for example, an area for describing details of operations to perform communication via the selected interface and a software button for displaying the area. When the software button is selected, the area is displayed as an Internet content by a web browser. A case where a web browser can be displayed refers to a case where the information processing apparatus 101 has re-established a connection with an access point with which the information processing apparatus 101 had connected before, enabling performing communication via the Internet.

As described above, according to the present exemplary embodiment, the CPU 103 can display the connection I/F options and the installation software options identified based on the identification information for the printing apparatus 115, 116, or 117 to be set up.

According to the present exemplary embodiment, the connection I/F between the printing apparatus 115 and the information processing apparatus 101 selected in step S307 is implemented in step S309. More specifically, before a connection is established between the printing apparatus 115 and the information processing apparatus 101 via the selected connection I/F in step S309, the CPU 103 can perform the processing in FIG. 3 by using a beacon issued from the printing apparatus 115.

This enables reducing the possibility of the setup processing failure due to the user selecting an interface not included in the communication apparatus. This also enables reducing the possibility of the installation processing failure due to the user selecting software that cannot instruct the communication apparatus to perform an operation.

If a customer demands to restrict the user's use of a specific communication I/F or specific software, communication I/Fs and pieces of installation software to be restricted are specified for each serial number. This specification enables the setup application to limit the display of the restricted communication I/Fs and pieces of specific software as options. This enables reducing the possibility of the user selecting a restricted software or communication FF. More specifically, if the demand is a demand of a customer who will purchase a communication apparatus having a serial number “00001 to 19999”, the display of the connection I/F options and the installation software options in the communication apparatus having a serial number “00001 to 19999” can be easily changed based on a customer's demand.

According to the above-described exemplary embodiment, the CPU 103 requests the server 121 to return information about the connection I/Fs and the installation software supported by the printing apparatus 115, and then receives the information from the server 121 which referred to the tables 601 and 602. However, instead of requesting the server 121, the CPU 103 can acquire information about the supported connection I/Fs and information about the supported installation software by referring to tables built in the setup program.

According to the above-described exemplary embodiment, the CPU 103 informs the user of the connection I/Fs and the installation software supported by the printing apparatus 115 by displaying the relevant information on the display unit 108. For example, if the information processing apparatus 101 includes an audio unit, the CPU 103 can audibly inform the user of the connection I/Fs and the installation software supported by the printing apparatus 115.

While, in the above-described exemplary embodiment, the setup program displays a screen including none of the restricted communication I/F options and software options, the present disclosure is not limited thereto.

For example, the restricted communication I/F options and software options can be displayed in gray to prevent them from being selected by the user. More specifically, the setup program can display a screen for limiting the selection of the restricted communication I/F options and software options.

While, in the above-described exemplary embodiment, the CPU 103 displays the connection I/F options and the installation software options in different screens, in another exemplary embodiment these options can be displayed in a single screen. For example, the screen 701 in FIG. 7 and the screen 801 in FIG. 8 can be displayed as one screen. In this case, the processing in step S307 and the processing in step S308 in FIG. 3 can be integrated into one piece of processing.

According to the above-described first exemplary embodiment, the CPU 103 extracts the identification information for the printing apparatus 115 from the setup SSID 304 of the printing apparatus 115 selected by the user. According to a second exemplary embodiment, the setup SSID 304 includes keyword information in addition to the model name and the serial number as the identification information for the printing apparatus 115. The keyword information includes keyword information for the connection I/F as information indicating the connection I/Fs to be notified to the user as connection I/F options, and keyword information for the installation software as information indicating the software to be notified to the user as software options. The present exemplary embodiment will be described below with respect to a form in which the CPU 103 notifies the user of the connection I/Fs and the installation software based on at least the keyword information as the identification information for the printing apparatus 115. In the following description of the present exemplary embodiment, similar components to those in the first exemplary embodiment will not be described.

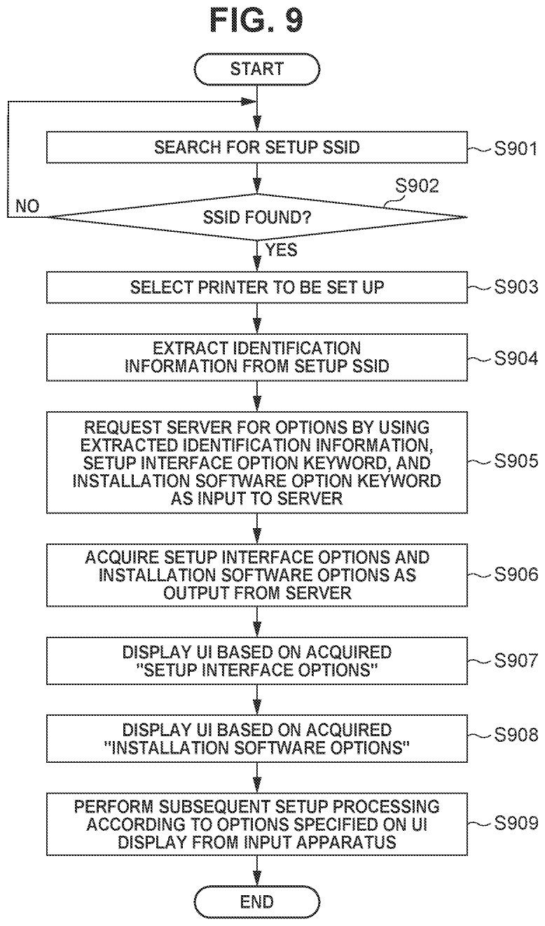

FIG. 9 is a flowchart illustrating processing performed by the information processing apparatus 101 in the printing apparatus setup processing according to the present exemplary embodiment. The flowchart illustrated in FIG. 9 is implemented, for example, when the CPU 103 loads the setup program stored in the ROM 104 or the external storage device 106 into the RAM 105, and then executes the setup program. The flowchart illustrated in FIG. 9 is started upon execution of a predetermined operation (hereinafter referred to as a setup operation) for performing the setup processing in the screen displayed by the setup program.

Processing in steps S901 to S903 is similar to the processing in steps S301 to S303 in FIG. 3, respectively, and as such, descriptions thereof will be omitted.

In step S904, the CPU 103 extracts at least the keyword information from the identification information for the printing apparatus 115 from the setup SSID 304 of the selected printing apparatus. The setup SSID 304 of the printing apparatus 115 is illustrated as an item 502 in FIG. 5. The CPU 103 extracts, from among the character strings of the setup SSID 304 delimited by underscores, the keyword information for the installation software, the keyword information for the connection I/Fs, the serial number, and the model name in this order from the right end of the character string to the left. In this case, keyword information “A” for the installation software, keyword information “1” for the connection I/Fs, a model name “XK999”, and a serial number “55555” are extracted. The setup SSID 304 does not necessarily need to include the entire serial number, and can include only a part of the serial number. The model name and the serial number do not necessarily need to be included in the setup SSID 304, and the extraction of the model name and the serial number is not a prerequisite.

In step S905, the CPU 103 requests the server 121 to return information about the supported connection I/Fs and information about the supported installation software based on at least the keyword information for the printing apparatus 115. For example, the CPU 103 requests the server 121 to return information about the connection I/Fs and the installation software supported by the printing apparatus 115 by using the model name “XK999”, the serial number “55555”, the keyword information “1” for the connection I/Fs, and the keyword information “A” for the installation software as an input to the server 121. The input of the serial number is not a prerequisite. In a case where the setup SSID 304 does not include the model name, the CPU 103 does not necessarily need to perform the processing in steps S905 and S906. More specifically, in a case where the printing apparatus 115 is selected in step S903, the CPU 103 determines whether the setup SSID 304 includes the model name. If the CPU 103 determines that the setup SSID 304 includes the model name, the CPU 103 performs the processing in step S904 and subsequent steps. If the CPU 103 determines that the SSID 304 does not include the model name, the CPU 103 omits the processing in steps S904 and S905. In step S907, the CPU 103 displays all of the connection I/F options prepared by the setup program. The CPU 103 displays all of the software options that can be provided by using the setup program in step S908 (described below). In a case where the setup SSID 304 does not include the model name, the product name (model name) is not displayed in the display screen in FIG. 4.

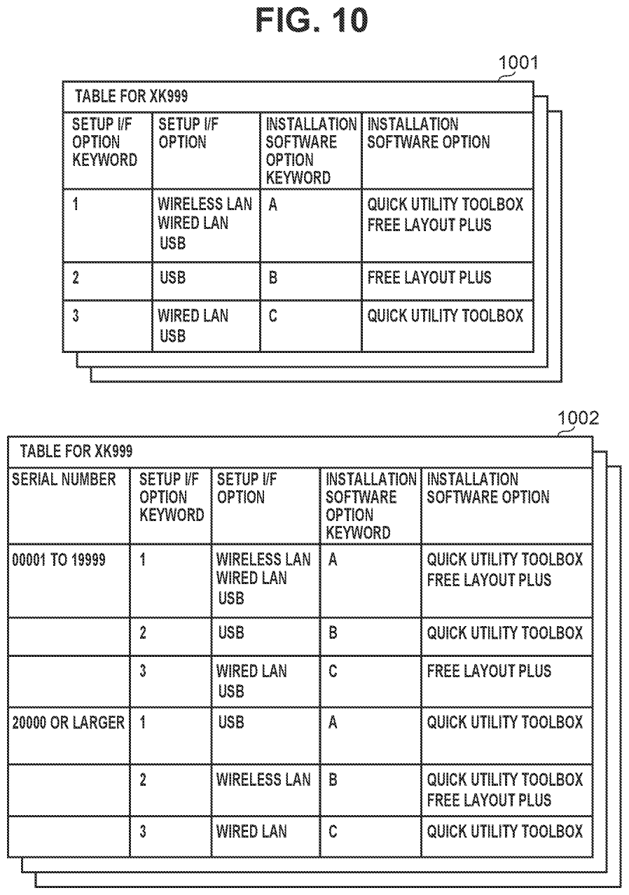

In step S906, the CPU 103 receives the information about the connection I/Fs and the information about the installation software returned as an output from the server 121. The conversion from input to output is performed by using tables stored in the server 121. For example, in a case where the model name “XK999”, the keyword information “1” for the connection I/Fs, and the keyword information “A” for the installation software are input to the server 121, a table 1001 illustrated in FIG. 10 is used. In this case, based on the table values, “Wireless LAN/Wired LAN/USB” is output as the information about the connection I/Fs, and “Quick Utility Toolbox/Free Layout Plus” is output as the information about the installation software. For example, in a case where the model name “XK999”, the serial number “55555”, the keyword information “1” for connection I/Fs, and the keyword information “A” for the installation software are input to the server 121, a table 1002 illustrated in FIG. 10 is used. In this case, based on the table values, “USB” is output as the information about the connection I/Fs and “Quick Utility Toolbox” is output as the information about the installation software.

In step S907, the CPU 103 displays the information about the connection I/Fs acquired in step S306, as options on the display unit 108 of the information processing apparatus 101. Examples of display screens are illustrated in FIG. 7. Assume a case where the CPU 103 requests the server 121 to return information about the connection I/Fs and information about the installation software, by using the model name “XK999”, the keyword information “1” for connection I/Fs, and the keyword information “A” for installation software as an input to the server 121 in step S905. When the values obtained by referring to the table 1001 in FIG. 10 are returned from the server 121, a display screen 701 is displayed.

Assume a case where the CPU 103 requests the server 121 to return information about the connection I/Fs and information about the installation software, by using the model name “XK999”, the serial number “55555”, the keyword information “1” for connection I/Fs, and the keyword information “A” for installation software as an input to the server 121 in step S905. When the values obtained by referring to the table 1002 in FIG. 10 are returned from the server 121, a display screen 702 is displayed. This means that the connection I/Fs supported by the printing apparatus 115 can differ based on the serial number, even with the same model name of the printing apparatus 115. Accordingly, referencing the serial number of the printing apparatus 115 in addition to the model name thereof enables displaying in more detail the connection I/Fs supported by the printing apparatus 115 to be set up.

Referring to the screens 701 and 702 in FIG. 7, the user selects one of the connection I/Fs to be used in the setup processing of the printing apparatus 115, by using the input interface 102 such as the mouse of the information processing apparatus 101, and then selects a “Next” button 703. This enables the CPU 103 to recognize the connection I/F to be used in the setup processing of the printing apparatus 115. In a case where only one connection I/F option is acquired in step S906, step S907 can be skipped.

In step S908, the CPU 103 displays the information about the installation software acquired in step S306 as options on the display unit 108 of the information processing apparatus 101. The display screen 801 is illustrated in FIG. 8. Assume a case where the CPU 103 requests the server 121 to return information about the connection I/Fs and information about the installation software, by using the model name “XK999”, the keyword information “1” for connection I/Fs, and the keyword information “A” for installation software as an input to the server 121 in step S305. When the values obtained by referring to the table 1001 in FIG. 10 are returned from the server 121, a display screen 801 is displayed. Assume a case where the CPU 103 requests the server 121 to return information about the connection I/Fs and information about the installation software, by using the model name “XK999”, the serial number “55555”, the keyword information “1” for connection I/Fs, and the keyword information “A” for installation software as an input to the server 121 in step S905. When the values obtained by referring to the table 1002 in FIG. 10 are returned from the server 121, a display screen 802 is displayed. This means that the installation software supported by the printing apparatus 115 can differ based on the serial number, even with the same model name of the printing apparatus 115. Accordingly, referencing the serial number of the printing apparatus 115 in addition to the model name thereof enables displaying in more detail the installation software supported by the printing apparatus 115 to be set up.

An example of an effect obtained by the acquisition of the keyword information will be described below. Assume an example case where keyword information “B” for the installation software, keyword information “2” for the connection I/Fs, a model name “XK999”, and a serial number “55555” are extracted from the setup SSID 304. In this case, based on the table values, “Wireless LAN” is output as the information about the connection I/Fs, and “Quick Utility Toolbox/Free Layout Plus” is output as the information about the installation software. Therefore, the options displayed to the user are also based on this output. As described above, if printing apparatuses having a similar model name and a similar serial number are provided with different keyword information, the printing apparatuses can support different connection I/Fs and different pieces of installation software. Accordingly, referencing the keyword information for the printing apparatus 115 in addition to the model name and the serial number thereof enables displaying in more detail the installation software supported by the printing apparatus 115 to be set up. Alternatively, even when the serial number is not referenced, the CPU 103 can display the connection I/Fs and the installation software in different ways from among printing apparatuses of the same model.

Processing in step S909 is similar to the processing in step S309, and thus, a detailed description is omitted.

As described above, according to the present exemplary embodiment, the CPU 103 can display the connection I/F options and the installation software options identified based on the identification information for the printing apparatus 115, 116, or 117 to be set up.

In addition, the CPU 103 acquires the keyword information for the connection I/Fs and the keyword information for the installation software as the identification information for the printing apparatus, enabling displaying in more detail the installation software supported by the printing apparatus 115 to be set up.

Alternatively, in a case where the serial number is not referenced, the CPU 103 can display the connection I/Fs and the installation software in different ways even with the same model according to a customer's demand.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, these embodiments are not seen to be limiting. The scope of the following claims is to be accorded the broadest interpretation so as to encompass all such modifications and equivalent structures and functions.

This application claims the benefit of Japanese Patent Application No. 2022-024924, filed Feb. 21, 2022, which is hereby incorporated by reference herein in its entirety.

What is claimed is:

1. A method for controlling an information processing apparatus, the method comprising:
acquiring identification information for a communication apparatus from the communication apparatus; and
displaying information indicating one or more connection interfaces included in the communication apparatus, the one or more connection interfaces being identified based on the acquired identification information,
wherein, in a case where the acquired identification information is acquired from the communication apparatus including a plurality of connection interfaces, information indicating the plurality of connection interfaces is displayed.

2. The method for controlling an information processing apparatus according to claim 1, further comprising displaying information indicating one or more pieces of software supported by the communication apparatus, wherein the software is identified based on the identification information.

3. The method for controlling an information processing apparatus according to claim 2, wherein the displayed information indicating one or more connection interfaces and the displayed information indicating one or more pieces of software are displayed on a same screen.

4. The method for controlling an information processing apparatus according to claim 2, wherein the displayed information indicating one or more connection interfaces and the displayed information indicating one or more pieces of software are displayed on different screens.

5. The method for controlling an information processing apparatus according to claim 2, wherein the one or more pieces of software is installed in the information processing apparatus.

6. The method for controlling an information processing apparatus according to claim 1, wherein a selection screen is displayed as part of displaying the information indicating one or more connection interfaces that enables selection of one connection interface from among the information indicating the one or more connection interfaces included in the communication apparatus, wherein the connection interfaces are identified based on the acquired identification information.

7. The method for controlling an information processing apparatus according to claim 6, further comprising displaying a tutorial screen indicating a method for performing connection processing using the connection interface selected via the selection screen.

8. The method for controlling an information processing apparatus according to claim 7, wherein, in a case where a wireless Local Area Network (LAN) interface is selected, the tutorial screen is displayed to enable the communication apparatus to connect with an access point forming a network using the wireless LAN interface.

9. The method for controlling an information processing apparatus according to claim 8, wherein, in a case where the wireless LAN interface is selected, connection information is transmitted to an access point used to connect the communication apparatus with the access point forming a network using the wireless LAN interface.

10. The method for controlling an information processing apparatus according to claim 7, wherein, in a case where a wired LAN interface is selected, the tutorial screen is displayed to prompt a connection of a wired LAN cable.

11. The method for controlling an information processing apparatus according to claim 7, wherein, in a case where a universal serial bus (USB) interface is selected, the tutorial screen is displayed to prompt a connection of a USB cable.

12. The method for controlling an information processing apparatus according to claim 1, wherein, in a case where the identification information and additional information are acquired, only one connection interface from among the one or more connection interfaces included in the communication apparatus identified based on the additional information is displayed.

13. The method for controlling an information processing apparatus according to claim 12, wherein the additional information is a serial number.

14. The method for controlling an information processing apparatus according to claim 12, wherein the additional information is keyword information.

15. The method for controlling an information processing apparatus according to claim 1, wherein the one or more connection interfaces identified based on the identification information are acquired from a server.

16. The method for controlling an information processing apparatus according to claim 15, wherein information indicating a first connection interface and information indicating a first software are identified based on the identification information in a table, included in the server, describing the information indicating the first connection interface and the information indicating the first software for each piece of the identification information, wherein the information indicating the first connection interface and the information indicating the first software are received by the information processing apparatus.

17. The method for controlling an information processing apparatus according to claim 1, wherein the identification information is acquired from a storage unit of the information processing apparatus.

18. The method for controlling an information processing apparatus according to claim 1, wherein the identification information is acquired by a beacon transmitted by the communication apparatus.

19. The method for controlling an information processing apparatus according to claim 1, wherein a connection interface to be used is a wireless LAN interface, a wired LAN interface, or a USB interface.

20. An information processing apparatus comprising:
an acquisition unit configured to acquire identification information for a communication apparatus from the communication apparatus; and
a display unit configured to display information indicating one or more connection interfaces included in the communication apparatus, the one or more connection interfaces being identified based on the acquired identification information,
wherein, in a case where the acquired identification information is acquired from the communication apparatus including a plurality of connection interfaces, information indicating the plurality of connection interfaces is displayed.

21. A non-transitory storage medium storing a program for causing a computer of an information processing apparatus to perform:
acquiring identification information for a communication apparatus from the communication apparatus; and
displaying information indicating one or more connection interfaces included in the communication apparatus, the one or more connection interfaces being identified based on the acquired identification information,
wherein, in a case where the acquired identification information is acquired from the communication apparatus including a plurality of connection interfaces, information indicating the plurality of connection interfaces is displayed.
